(19) United States
(12) Patent Application Publication
(10) Pub. No.: US 2019/0079903 A1
(43) Pub. Date: Mar. 14, 2019

(54) PROVIDING MATRIX MULTIPLICATION USING VECTOR REGISTERS IN PROCESSOR-BASED DEVICES

(71) Applicant: QUALCOMM Incorporated, San Diego, CA (US)

(72) Inventors: Robert Dreyer, Menlo Park, CA (US); Mattheus Cornelis Antonius Adrianus Heddes, Raleigh, NC (US); Colin Beaton Verrilli, Apex, NC (US); Natarajan Vaidhyanathan, Carrboro, NC (US); Koustav Bhattacharya, Austin, TX (US)

(21) Appl. No.: 16/129,480

(22) Filed: Sep. 12, 2018

Related U.S. Application Data
(60) Provisional application No. 62/558,544, filed on Sep. 14, 2017.

(51) Int. Cl. G06F 17/16; G06F 15/80

(52) U.S. Cl. CPC G06F 17/16; G06F 15/8076

(57) ABSTRACT

Providing matrix multiplication using vector registers in processor-based devices is disclosed. In one aspect, a method for providing matrix multiplication comprises rearranging elements of a first submatrix and a second submatrix into first and second vectors, respectively, which are stored in first and second vector registers. A matrix multiplication vector operation using the first and second vector registers as input operands is then performed to generate an output vector that is stored in an output vector register. Each element E of the output vector, where 0≤E<R_{A}C_{B}, is calculated as a dot product of a plurality of elements of the first vector corresponding to a row of the first submatrix, and a plurality of elements of the second vector corresponding to a column of the second submatrix.

### PRIORITY APPLICATION

The present application claims priority under 35 U.S.C. § 119(e) to U.S. Provisional Patent Application Ser. No. 62/558,544 entitled “PROVIDING MATRIX MULTIPLICATION USING VECTOR REGISTERS IN PROCESSOR-BASED SYSTEMS” and filed on Sep. 14, 2017, the contents of which is incorporated herein by reference in its entirety.

### BACKGROUND

### I. Field of the Disclosure

The technology of the disclosure relates generally to matrix handling in processor-based devices, and, in particular, to techniques for efficient matrix multiplication using vector registers.

### II. Background

Matrix multiplication is a mathematical operation having numerous applications in applied mathematics, physics, engineering, and computer science. In the context of computer science and computer engineering, the multiplication of matrices is fundamental to applications as varied as rendering three-dimensional (3D) graphics, simulating quantum mechanics, modeling financial systems, and developing machine learning algorithms. However, the performance of such applications may be limited by the computational complexity of matrix multiplication operations. For example, the conventional algorithm for multiplying two matrices with dimensions n×n (for an integer n≥2) has a computational complexity of O(n³). As such, the optimization of matrix multiplication operations has the potential to greatly improve a wide variety of applications.

Conventional attempts to provide efficient matrix multiplication have resulted in development of both hardware-based approaches (e.g., dedicated co-processors, matrix units, and the like) as well as software algorithms (e.g., vector-instruction-based sequences for accomplishing matrix multiplication). Each approach, however, has encountered significant challenges. For example, dedicated co-processors for performing matrix multiplication, such as Google's Tensor Processing Unit (TPU), may provide high peak performance, but may prove incapable of extracting performance across a range of operations. Similarly, software-based approaches may have limitations in handling floating-point or integer computations, or may be difficult or awkward to program. Thus, an efficient apparatus for performing matrix multiplication operations is desirable.

### SUMMARY OF THE DISCLOSURE

Aspects disclosed in the detailed description include providing matrix multiplication using vector registers in processor-based devices. In this regard, a processor-based device provides a matrix processing unit and a vector processing unit configured to provide a true matrix multiplication vector instruction expressed as a register-to-register operation. In some aspects, input matrices may first be “blocked” or “tiled” (i.e., organized into smaller submatrices that better fit into the memory hierarchy and/or register file). The elements within each submatrix are rearranged into a format allowing the contents of the submatrix to be loaded into a vector register. A matrix multiplication vector operation (e.g., initiated by executing a matrix multiplication vector instruction) is then used to perform matrix multiplication on the contents of two vector registers storing the rearranged contents of a pair of submatrices, and the result is stored in a third vector register. In this manner, a matrix multiplication operation having a computational complexity of O(n³) can be encoded in a vector instruction having O(n²) elements, which enables a simple sequence of software instructions to efficiently produce a product of large matrices.

In another aspect, a processor-based device method for performing matrix multiplication operations using vector registers is provided. The processor-based device comprises a matrix processing unit, as well as a vector processing unit comprising a plurality of vector registers. The matrix processing unit is configured to rearrange a plurality of elements of a first submatrix having a number R_{A} rows and a number C_{A} columns into a first vector having a number of elements equal to the product of R_{A} and C_{A} (R_{A}C_{A}). The matrix processing unit is further configured to store the first vector in a first vector register of the plurality of vector registers of the vector processing unit. The matrix processing unit is also configured to rearrange a plurality of elements of a second submatrix having a number R_{B} rows and a number C₈ columns into a second vector having a number of elements equal to the product of R_{B} and C_{B} (R_{B}C_{B}). The matrix processing unit is additionally configured to store the second vector in a second vector register of the plurality of vector registers of the vector processing unit. The vector processing unit is configured to perform a matrix multiplication vector operation using the first vector register and the second vector register as input operands to generate an output vector having a number of elements equal to the product of R_{A} and C_{B} (R_{A}C_{B}), wherein each element E of the output vector, where 0≤E<R_{A}C_{B}, is calculated as a dot product of a plurality of elements of the first vector corresponding to a row of the first submatrix, and a plurality of elements of the second vector corresponding to a column of the second submatrix. The vector processing unit is further configured to store the output vector in a third vector register of the plurality of vector registers of the vector processing unit.

In another aspect, a processor-based device for performing matrix multiplication operations using vector registers is provided. The processor-based device comprises a means for rearranging a plurality of elements of a first submatrix having a number R_{A} rows and a number C_{A} columns into a first vector having a number of elements equal to the product of R_{A} and C_{A} (R_{A}C_{A}). The processor-based device further comprises a means for storing the first vector in a first vector register of a plurality of vector registers. The processor-based device also comprises a means for rearranging a plurality of elements of a second submatrix having a number R₈ rows and a number C_{B} columns into a second vector having a number of elements equal to the product of R_{B} and C_{B} (R_{B}C_{B}). The processor-based device additionally comprises a means for storing the second vector in a second vector register of the plurality of vector registers. The processor-based device further comprises a means for performing a matrix multiplication vector operation using the first vector register and the second vector register as input operands to generate an output vector having a number of elements equal to the product of R_{A} and C_{B} (R_{A}C_{B}), wherein each element E of the output vector, where 0≤E<R_{A}C_{B}, is calculated as a dot product of a plurality of elements of the first vector corresponding to a row of the first submatrix, and a plurality of elements of the second vector corresponding to a column of the second submatrix. The processor-based device also comprises a means for storing the output vector in a third vector register of the plurality of vector registers.

In another aspect, a method for performing matrix multiplication operations using vector registers is provided. The method comprises rearranging, by a matrix processing unit of a processor-based device, a plurality of elements of a first submatrix having a number R_{A} rows and a number C_{A} columns into a first vector having a number of elements equal to the product of R_{A} and C_{A} (R_{A}C_{A}). The method further comprises storing, by the matrix processing unit, the first vector in a first vector register of a plurality of vector registers of a vector processing unit of the processor-based device. The method also comprises rearranging, by the matrix processing unit, a plurality of elements of a second submatrix having a number R_{B} rows and a number C_{B} columns into a second vector having a number of elements equal to the product of R_{B} and C_{B}(R_{B}C_{B}). The method additionally comprises storing, by the matrix processing unit, the second vector in a second vector register of the plurality of vector registers of the vector processing unit. The method further comprises performing, by the vector processing unit, a matrix multiplication vector operation using the first vector register and the second vector register as input operands to generate an output vector having a number of elements equal to the product of R_{A} and C_{B} (R_{A}C_{B}), wherein each element E of the output vector, where 0≤<R_{A}C_{B}, is calculated as a dot product of a plurality of elements of the first vector corresponding to a row of the first submatrix, and a plurality of elements of the second vector corresponding to a column of the second submatrix. The method also comprises storing, by the vector processing unit, the output vector in a third vector register of the plurality of vector registers of the vector processing unit.

### BRIEF DESCRIPTION OF THE FIGURES

FIGS. 1A and 1B are block diagrams of an exemplary processor-based device configured to provide matrix multiplication using vector registers;

FIG. 2 is a block diagram illustrating matrix multiplication as performed by conventional processor-based devices;

FIG. 3 is a block diagram illustrating tiling of exemplary input matrices and rearranging of contents of tiled submatrices;

FIG. 4 is a block diagram illustrating rearranged contents of two (2) submatrices and an output vector resulting from a matrix multiplication vector operation;

FIG. 5 is a flowchart illustrating exemplary operations of the processor-based device of FIGS. 1A and 1B for performing matrix multiplication using vector registers; and

FIG. 6 is a block diagram of an exemplary processor-based device that can comprise the processor-based device of FIGS. 1A and 1B for providing matrix multiplication using vector registers.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

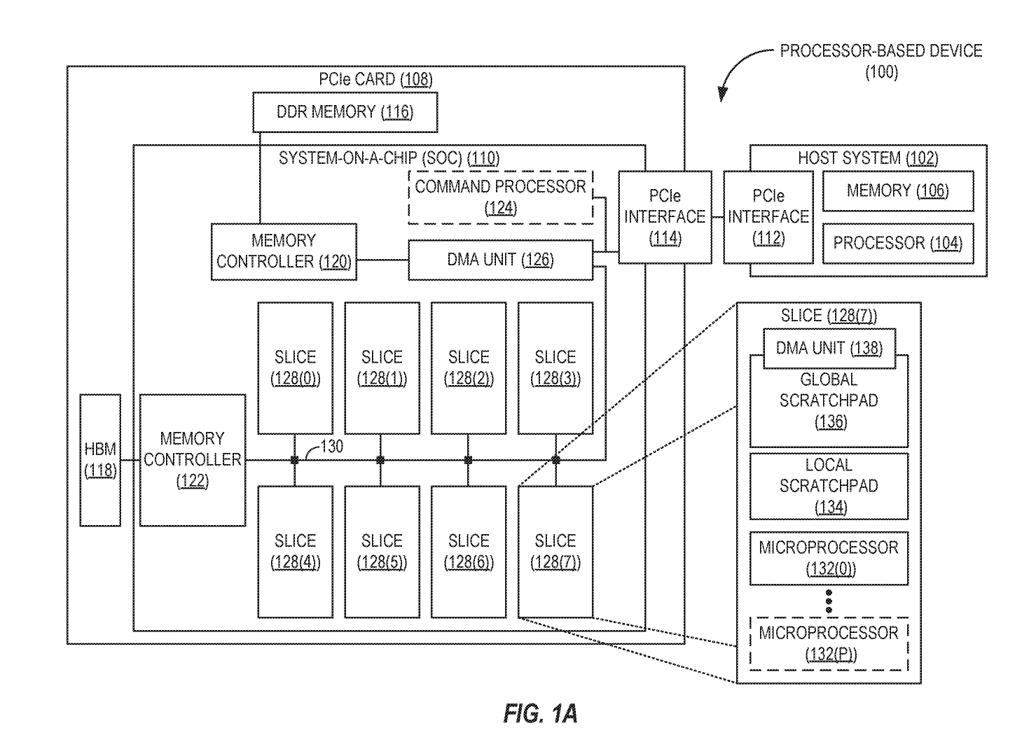

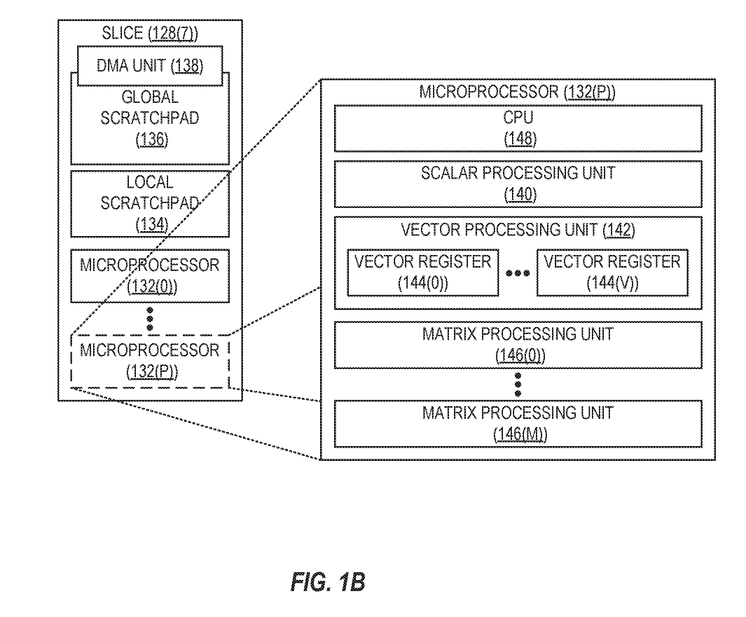

Aspects disclosed in the detailed description include providing matrix multiplication using vector registers in processor-based devices. In this regard, FIGS. 1A and 1B illustrate an exemplary processor-based device 100 configured to provide efficient matrix multiplication using vector registers. Referring to FIG. 1A, the processor-based device 100 provides a host system 102, which in some aspects may comprise an ARM®- or INTEL® x86-based server computer. The host system 102 includes a processor 104 (e.g., one or more central processing units (CPUs), processors, and/or processor cores) and memory 106 (e.g., double data rate (DDR) synchronous dynamic random access memory (SDRAM) (DDR SDRAM)). The processor-based device 100 further provides a Peripheral Component Interconnect Express (PCIe) card 108, on which a system-on-a-chip (SoC) 110 is configured to communicate with the host system 102 via a PCIe interface 112 of the host system 102 and a PCIe interface 114 of the SoC 110. The PCIe card 108 also includes DDR memory 116 and high-bandwidth memory (HBM) 118, which interface with the SoC 110 via a memory controller 120 and a memory controller 122, respectively.

In the example of FIG. 1A, the SoC 110 provides an optional command processor 124, which in some aspects may comprise a conventional processor such as an ARM®- or INTEL® x86-based processor. The SoC 110 also includes a direct memory access (DMA) unit 126 that is configured to move data to and from the DDR memory 116 and the PCIe interface 114, and thereby to and from the host system 102. The SoC 110 of FIGS. 1A and 1B provides eight (8) processor slices (“slices”) 128(0)-128(7), which are interconnected by a network-on-chip (NoC) 130. It is to be understood that, in some aspects, the SoC 110 may include more or fewer slices 128(0)-128(7) than illustrated in FIG. 1A.

To illustrate the constituent elements of the slices 128(0)-128(7), FIG. 1A shows an expanded view of the slice 128(7). The slice 128(7) comprises one or more microprocessors 132(0)-132(P), along with a local scratchpad 134 and a global scratchpad 136. The local scratchpad 134 is a high-bandwidth memory that is accessible only by the microprocessor(s) 132(0)-132(P) of the slice 128(7). In contrast, the global scratchpad 136 is a lower-bandwidth memory that is accessible by any of the slices 128(0)-128(7). To move data into and out of the local scratchpad 134 and the global scratchpad 136, the slice 128(7) provides a DMA unit 138, which is communicatively coupled to the NoC 130. It is to be understood that, in this example, each of the slices 128(0)-128(6) include elements corresponding to the elements of the slice 128(7) described above.

FIG. 1B provides a more detailed view of the constituent elements of the one or more microprocessors 132(0)-132(P) of the slice 128(7) of FIG. 1A, using the microprocessor 132(P) as an example. As seen in FIG. 1B, the microprocessor 132(P) provides a scalar processing unit 140 and a vector processing unit 142. The vector processing unit 142 includes a plurality of vector registers 144(0)-144(V), each configured to store a plurality of vector elements (not shown) upon which vector operations may be performed. The microprocessor 132(P) further provides a plurality of matrix processing units 146(0)-146(M). In the example of FIG. 1B, the matrix processing units 146(0)-146(M) are configured to use 16-bit floating-point precision, as higher precision is both unnecessary for machine learning applications and also results in reduced performance. The scalar processing unit 140, the vector processing unit 142, and the matrix processing units 146(0)-146(M) are controlled by a CPU 148, which in some aspects provides a specialized instruction set for matrix processing. It is to be understood that, in the example of FIGS. 1A and 1B, each of the microprocessor(s) 132(0)-132(P) includes elements corresponding to the elements of the microprocessor 132(P) described above.

The processor-based device 100 and its constituent elements as illustrated in FIGS. 1A and 1B may encompass any known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor sockets or packages. It is to be understood that some aspects of the processor-based device 100 may include elements in addition to those illustrated in FIGS. 1A and 1B, and/or may omit some elements illustrated in FIGS. 1A and 1B.

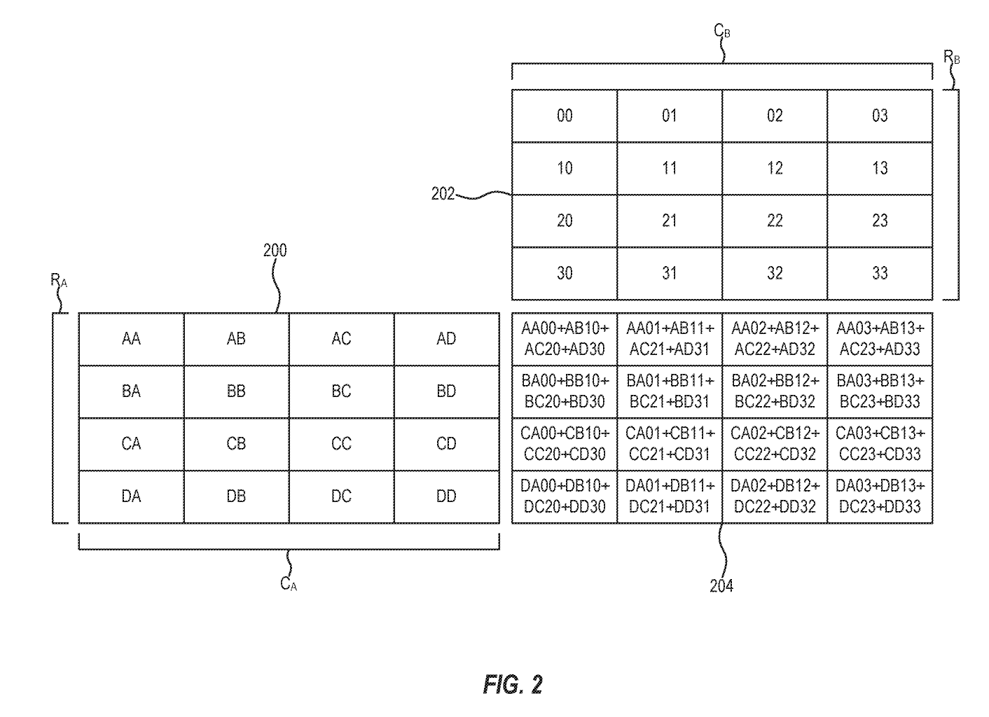

Before discussing using vector registers to perform a matrix multiplication operation as disclosed herein, the calculations used by a conventional matrix processing unit when performing matrix multiplication is first discussed. In this regard, FIG. 2 is provided. To perform matrix multiplication, each element of an output matrix is calculated as a “dot product,” a sum of the products of elements of a corresponding row of a first input matrix and elements of a corresponding column of a second input matrix. As seen in FIG. 2, two input matrices 200 and 202 are provided, where the input matrix 200 has a number R_{A} of rows and a number C_{A} of columns and the input matrix 202 has a number R_{B} of rows and a number C_{B} of columns. In the example of FIG. 2, R_{A}, C_{A}, R_{B}, and C_{B} all have a value of four (4), and thus the input matrices 200, 202 are each made up of four (4) rows and four (4) columns and may be referred to as “4×4” matrices. The elements of the input matrix 200 are each designated by two letters, with the first letter indicating the row containing the element and the second letter indicating the column of the element. Thus, for example, element BC of the input matrix 200 resides in row B, column C of the input matrix 200. Similarly, the elements of the input matrix 202 are designated with two numbers, with the first number indicating the row of the element and the second number indicating the column of the element.

An output matrix 204 represents the result of a matrix multiplication operation on the input matrices 200 and 202, and indicates the computations used to generate each element of the output matrix 204. For example, the upper-left-most element of the output matrix 204 is computed by summing the products of elements of row A of the input matrix 200 with elements of column 1 of the input matrix 202. Accordingly, the value of the upper-left-most element of the output matrix 204 is the sum of the products of element AA of the input matrix 200 and element 00 of the input matrix 202, element AB of the input matrix 200 and element 10 of the input matrix 202, element AC of the input matrix 200 and element 20 of the input matrix 202, and element AD of the input matrix 200 and element 30 of the input matrix 202. Corresponding computations are made for each of the other elements of the output matrix 204. The resulting output matrix has dimensions R_{A} by C_{B}, which in the example of FIG. 2 is four (4) by four (4).

As seen in FIG. 2, performing matrix multiplication is computationally intense, and in fact, a naïve algorithm for multiplying two matrices with dimensions n×n (for an integer n≥2) has a computational complexity of O(n³). Because of the prevalence of matrix multiplication operations in deep learning applications, optimization of matrix multiplication has remained a focus of research. One approach seeks to improve the computational complexity of matrix multiplication using vector instructions and corresponding vector registers. However, existing approaches do not incorporate the concept of matrices in the processor's instruction set or microarchitecture, and thus require sequences of vector instructions in order to perform matrix multiplication. Thus, it is desirable to provide a method to enable software to efficiently deliver data to the matrix processing units 146(0)-146(M) of FIGS. 1A and 1B and deliver results of matrix multiplication operations from the matrix processing units 146(0)-146(M), while enabling flexible implementations in hardware.

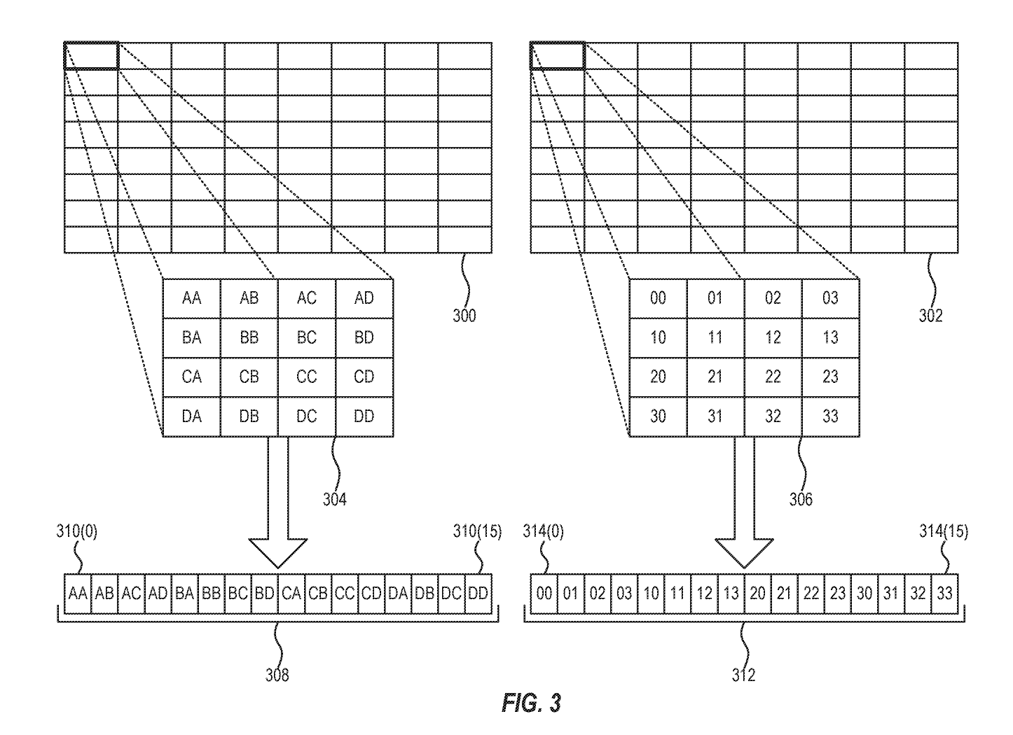

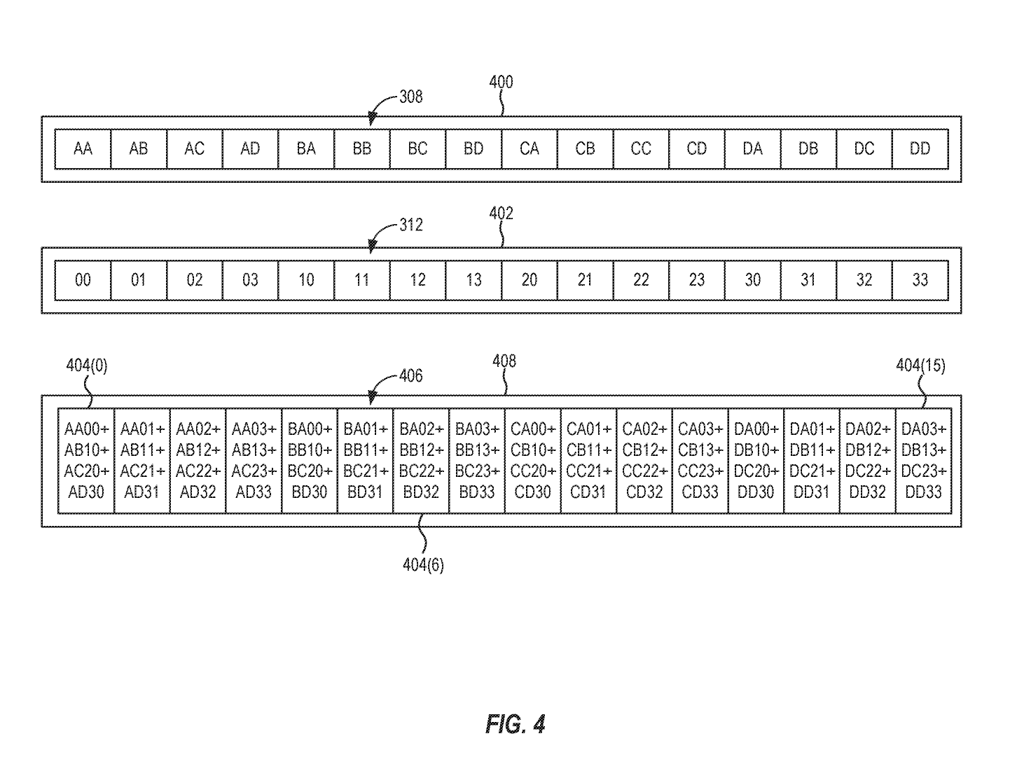

In this regard, the matrix processing units 146(0)-146(M) and the vector processing unit 142 of FIG. 1B are configured to provide a true matrix multiplication vector instruction expressed as a register-to-register operation. As discussed in greater detail below with respect to FIGS. 3 and 4, each input matrix (such as the input matrices 200 and 202 of FIG. 2) are first “blocked” or “tiled” (i.e., organized into smaller submatrices that better fit into the memory hierarchy and/or register file). Note that, in some aspects, either one of the input matrices 200 and 202 may not be larger than a size of the memory hierarchy and/or register file (e.g., 32×32, as a non-limiting example), but rather may have a size the same as the memory hierarchy and/or register file, or may be smaller but zero-padded. Additionally, the submatrices into which the input matrices 200 and 202 are blocked or tiled may be equal in size to the entire corresponding input matrix 200, 202. After the input matrices 200 and 202 have been subdivided into submatrices, the data within each submatrix is then rearranged into a format allowing the contents of the submatrix to be loaded into a vector register, such as one of the vector registers 144(0)-144(V) of the vector processing unit 142 of FIG. 1B. Finally, a matrix multiplication vector instruction is provided by the vector processing unit 142 to perform a matrix multiplication on the contents of two vector registers. In this manner, a matrix multiplication operation having a computational complexity of O(n³) can be encoded in a vector instruction having n² elements, which enables a simpler sequence of software instructions to efficiently produce a product of large matrices.

As noted above, it is not uncommon for one or both matrices upon which a matrix multiplication operation is to be performed to be larger than a conventional size of the memory hierarchy and/or register files of the matrix processing units 146(0)-146(M). Accordingly, the matrices may be organized into smaller submatrices through a process known as blocking or tiling. In this regard, FIG. 3 illustrates how exemplary input matrices 300, 302 may be tiled and contents of one of the submatrices subsequently rearranged in preparation for multiplication. As seen in FIG. 3, the input matrices 300, 302 are 32×32 matrices that are each conceptually divided into 64 submatrices arranged in eight (8) rows and eight (8) columns. Submatrices 304, 306 represent exemplary submatrices of the input matrices 300 and 302, respectively, and each comprises a 4×4 matrix similar to the input matrices 200, 202 of FIG. 2. In performing a matrix multiplication operation, the matrix processing units 146(0)-146(M) may “walk” through the submatrices of each of the input matrices 300, 302, processing each one in turn as described herein with respect to the submatrices 304, 306. Note that in some aspects, the input matrices 300, 302 and the submatrices 304, 306 may be larger or smaller than illustrated in FIG. 3. For example, the submatrices 304, 306 each may be a 32×32 matrix that is sized to match the size of hardware provided by the matrix processing units 146(0)-146(M).

To optimize bandwidth usage and enable efficient delivery of data for matrix multiplication, the submatrices 304, 306 next are rearranged. When stored in memory, the contents of the rows of each submatrix 304, 306 may be widely separated in memory by the other contents of the rows of the original input matrices 300, 302 from which the submatrices 304, 306 are extracted (i.e., the contents of the rows of each of the submatrices 304, 306 are not contiguous in memory). This condition arises as a consequence of the format (e.g., row-major, column-major, or Iliffe vector format, as non-limiting examples) in which the input matrices 300, 302 are stored in memory. Thus, the processor-based device 100 of FIGS. 1A and 1B rearranges the contents of the submatrices 304, 306 into the layouts shown in FIG. 3. In particular, the four (4) rows of the submatrix 304 are arranged consecutively into a single vector 308 containing a number of elements equal to the product of the number of rows and the number of columns of the submatrix 36, which in this example results in 16 elements 310(0)-310(15). Similarly, the four (4) rows of the submatrix 306 are arranged consecutively into a single vector 312 of 16 elements 314(0)-314(15). The vectors 308, 312 may then be stored in a vector register, such as one of the vector registers 144(0)-144(V) of the vector processing unit 142, to be processed by a matrix multiplication vector instruction, as discussed below with respect to FIG. 4.

The reorganization of the contents of the submatrices 304, 306 may be performed as part of a data transfer between different elements of the processor-based device 100 of FIGS. 1A and 1B. In some aspects, reorganization may take place as data is transferred from an external memory, such as the DDR memory 116, into the HBM 118 and/or into an internal scratchpad memory such as the global scratchpad 136 of the slice 128(7). Some aspects may provide that the data may be reorganized during a copy operation within a same level of the memory hierarchy (e.g., during a copy operation within the DDR memory 116, the HBM 118, and/or the memory 106 of the host system 102, as non-limiting examples). According to some aspects, reorganization may also be accomplished by a “block-strided” load operation, or by a plurality of vector load operations that merge smaller vectors into a larger vector in the vector registers 144(0)-144(V) (e.g., performing 32 32-element vector loads, and merging them into a single 1024-element vector).

In some aspects, the processor-based device 100 provides a vector instruction specifically for retrieving and rearranging data for a single “tiled” submatrix from a larger input matrix. As a non-limiting example, the following instruction may be provided to load 32 groups of 32 values each:

LDSB destVR, src1SR, src2SR/imm

The LDSB instruction shown above takes three operands: “destVR,” which specifies a destination vector register among the vector registers 144(0)-144(V); “src1SR,” which indicates a scalar register for a start address of the submatrix; and “src2SR/imm,” which indicates either a second scalar register or an immediate value indicating a start address for a next block of 32 elements. Upon execution, the LDSB instruction uses the src1SR operand and the src2SR/imm operand to load 32 groups of 32 values (i.e., a 32×32 submatrix) into the vector register indicated by the destVR operand. In this manner, the vector registers 144(0)-144(V) can be efficiently loaded with the contents of submatrices of input matrices to be multiplied.

To actually perform the matrix multiplication operation after the LDSB instruction has been used to load input matrices, the processor-based device 100 further may provide a matrix multiplication vector instruction. In some aspects, the matrix multiplication vector instruction may be provided as follows:

VFMXM rdest, rsrc1, rsrc2

As seen above, the VFMXM instruction takes as operands “rdest,” which specifies a vector register among the vector registers 144(0)-144(V) in which contents of the output matrix will be stored, and “rsrc1” and “rsrc2,” which indicate the vector registers among the vector registers 144(0)-144(V) in which the contents of the first and second input matrices, respectively, are stored.

To illustrate operations performed upon execution of a matrix multiplication vector instruction, FIG. 4 is provided. As seen in FIG. 4, a first vector register 400 stores the vector 308 representing the rearranged contents of the submatrix 304 of FIG. 3. The first vector register 400 may be specified by the “rsrc1” operand of the VFMXM instruction described above. Likewise, a second vector register 402, which may be specified by the “rsrc2” operand of the VFMXM instruction, stores the vector 312 representing the rearranged contents of the submatrix 306. FIG. 4 further shows the operations performed during execution of the VFMXM instruction to generate each individual element 404(0)-404(15) of an output vector 406 that is then stored in a vector register 408 (which may be specified by the “rdest” operand of the VFMXM instruction). Stated generally, if the submatrix 304 has dimensions R_{A} by C_{A} and the submatrix 306 has dimensions R_{B} by C_{B}, then the number of elements 404 of the output vector 406 equals the product of R_{A} and C_{B} (R_{A}C_{B}), which is 16 in this example. For aspects in which the output vector 406 is arranged in row major order as shown in FIG. 4, each element E of the elements 404(0)-404(15) (where 0≤E<16) of the output vector 406 is calculated as a dot product of the plurality of elements of the vector 308 corresponding to a row of the submatrix 304 indicated by a quotient of E divided by R_{A} and a column of the submatrix 306 indicated by a remainder of E divided by Ca. Thus, for instance, element 6 (i.e., element 404(6)) of the output vector 406 is calculated as the dot product of row B (i.e., the quotient of 6 divided by 4 is 1, indicating the second row B) of the submatrix 304 and the column 2 (i.e., the remainder of 6 divided by 4 is 2, indicating the third column 2) of the submatrix 306. Alternatively, some aspects may provide that the output vector 406 is arranged in column major order, and thus each element E of the elements 404(0)-404(15) (where 0≤E<16) of the output vector 406 is calculated as a dot product of the plurality of elements of the vector 308 corresponding to a row of the submatrix 304 indicated by a remainder of E divided by R_{A} and a column of the submatrix 306 indicated by a quotient of E divided by C_{B}. The vector processing unit 142 may perform calculations in this manner to generate each element 404(0)-404(15) of the output vector 406.

Some aspects of the processor-based device 100 may be configured to perform matrix multiplication operations on matrices of different sizes such as 4×4, 8×8, 16×16, or 32×32 matrices, or even non-square sizes like 8×16, 16×8, and the like, as non-limiting examples. Additionally, aspects may provide support for matrix elements of different sizes formats (e.g., 8-bit signed or unsigned, 16-bit signed or unsigned, 16-bit floating-point, 32-bit floating-point, or 4-bit signed or unsigned, as non-limiting examples). The vector instruction for performing matrix multiplication according to some aspects may be provided with or without accumulation functionality. Some aspects may be provided with or without floating-point exceptions in line with the conventions of the host instruction set architecture (ISA), while some aspects may provide that results may be of a larger width than inputs (e.g., half-precision inputs may produce single precision results). Finally, in some aspects, data layout may not be strict row-by-row orientation, but may rather utilize a permutation functional unit to pre-swizzle data to minimize the number of large buses required in the matrix processing units 146(0)-146(M).

The mechanisms described above provide a true matrix multiplication instruction, expressed as a register-to-register operation, that encodes a O(n³) operation in an instruction with n² elements. This provides a concise model of computation that enables simpler software sequences to produce the product of larger matrices. Additionally, the underlying hardware implementation may be modified in some aspects to improve performance or reduce area in a manner that is transparent to software. For example, the number of multiply/accumulate (MAC) units may be varied, and/or support for special handling of sparse matrices may be provided. Hardware may also be modified by adding multiple functional units to execute in parallel. The mechanisms described herein may coexist with expected software-friendly processor ISA features such as breakpoints and exceptions, as well as hardware-friendly features such as load-store ISAs. They also are amenable to compiler optimizations such as code scheduling and register allocation. Additionally, the mechanisms described herein may be applied to performing other operations instead of or in addition to matrix multiplication and/or to operations requiring more operands than the submatrices 304, 306.

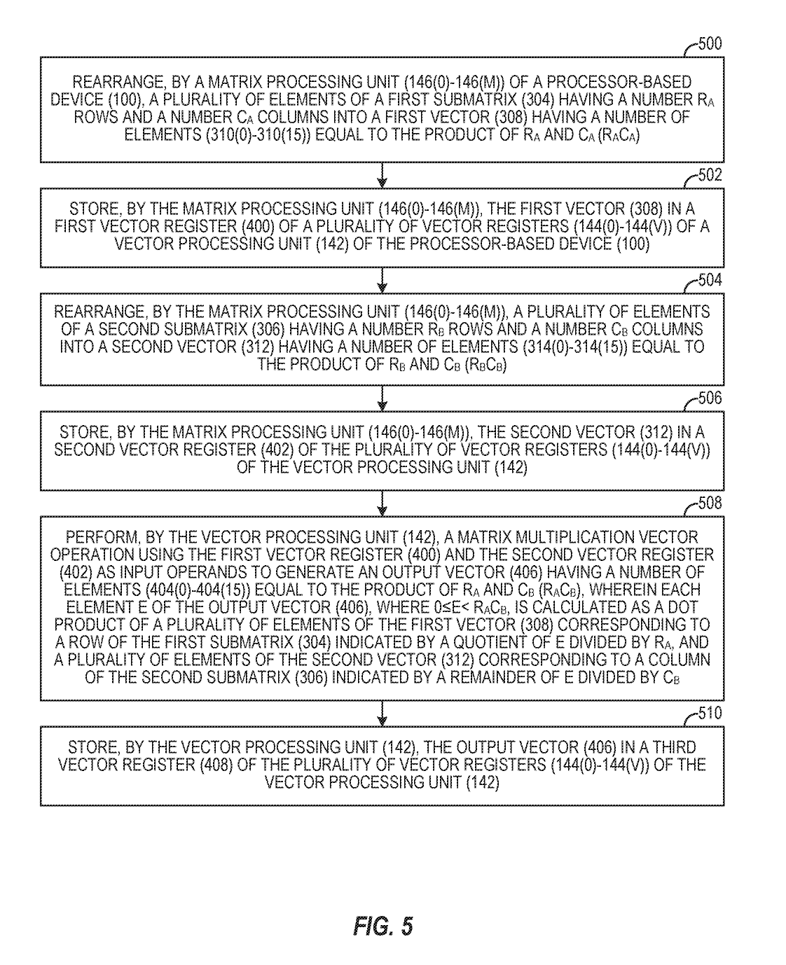

To illustrate exemplary operations of the processor-based device 100 of FIGS. 1A and 1B for performing matrix multiplication using vector operations, FIG. 5 is provided. For the sake of clarity, elements of FIGS. 1A, 1B, 2, 3, and 4 are referenced in describing FIG. 5. Operations in FIG. 5 begin with a matrix processing unit, such as one of the matrix processing units 146(0)-146(M) of the processor-based device 100, rearranging a plurality of elements of a first submatrix (such as the submatrix 304) having a number R_{A} rows and a number C_{A} columns into a first vector 308 having a number of elements 310(0)-310(15) equal to the product of R_{A} and C_{A} (R_{A}C_{A}) (block 500). In this regard, the matrix processing unit 146(0)-146(M) may be referred to herein as “a means for rearranging a plurality of elements of a first submatrix having a number R_{A} rows and a number C_{A} columns into a first vector having a number of elements equal to the product of R_{A} and C_{A} (R_{A}C_{A}).” The matrix processing unit 146(0)-146(M) then stores the first vector 308 in a first vector register, such as the vector register 400, of the plurality of vector registers 144(0)-144(V) of the vector processing unit 142 of the processor-based device 100 (block 502). Accordingly, the matrix processing unit 146(0)-146(M) may be referred to herein as “a means for storing the first vector in a first vector register of a plurality of vector registers.”

The matrix processing unit 146(0)-146(M) next rearranges a plurality of elements of a second submatrix, such as the submatrix 306, having a number R_{B} rows and a number C_{B} columns into a second vector 312 having a number of elements 314(0)-314(15) equal to the product of R_{B} and C_{B} (R_{B}C_{B}) (block 504). The matrix processing unit 146(0)-146(M) thus may be referred to herein as “a means for rearranging a plurality of elements of a second submatrix having a number R_{B} rows and a number C_{B} columns into a second vector having a number of elements equal to the product of R_{B} and C_{B} (R_{B}C_{B}).” The matrix processing unit 146(0)-146(M) then stores the second vector 312 in a second vector register, such as the vector register 402, of the plurality of vector registers 144(0)-144(V) of the vector processing unit 142 (block 506). In this regard, the matrix processing unit 146(0)-146(M) may be referred to herein as “a means for storing the second vector in a second vector register of the plurality of vector registers.”

The vector processing unit 142 then performs a matrix multiplication vector operation using the first vector register 400 and the second vector register 402 as input operands to generate an output vector 406 having a number of elements 404(0)-404(15) equal to the product of R_{A} and C_{B} (R_{A}C_{B}), wherein each element E of the output vector 406, where 0≤E<R_{A}C_{B}, is calculated as a dot product of a plurality of elements of the first vector 308 corresponding to a row of the first submatrix 304 indicated by a quotient of E divided by R_{A}, and a plurality of elements of the second vector 312 corresponding to a column of the second submatrix 306 indicated by a remainder of E divided by C_{B} (block 508). Accordingly, the vector processing unit 142 may be referred to herein as “a means for performing a matrix multiplication vector operation using the first vector register and the second vector register as input operands to generate an output vector having a number of elements equal to the product of R_{A} and C_{B} (R_{A}C_{B}), wherein each element E of the output vector, where 0≤E<R_{A}C_{B}, is calculated as a dot product of a plurality of elements of the first vector corresponding to a row of the first submatrix indicated by a quotient of E divided by R_{A}, and a plurality of elements of the second vector corresponding to a column of the second submatrix indicated by a remainder of E divided by C_{B}.” After performing the matrix multiplication vector operation, the vector processing unit 142 stores the output vector 406 in a third vector register, such as the vector register 408, of the plurality of vector registers 144(0)-144(V) of the vector processing unit 142 (block 510). The vector processing unit 142 thus may be referred to herein as “a means for storing the output vector in a third vector register of the plurality of vector registers.”

In some aspects, operations of blocks 500 and 504 for rearranging the plurality of elements of the first submatrix 304 and rearranging the plurality of elements of the second submatrix 306 may be performed by the matrix processing unit 146(0)-146(M) as part of operations for transferring data from an external memory, such as the DDR memory 116, to an internal scratchpad memory such as the global scratchpad 136 and/or the local scratchpad 134. In such aspects, the matrix processing unit 146(0)-146(M) may be referred to herein as “a means for rearranging a plurality of elements of a submatrix during one or more data transfer operations for transferring data from an external memory to an internal scratchpad memory.” Some aspects may provide that the operations of blocks 500 and 504 may be performed by the matrix processing unit 146(0)-146(M) during one or more data transfer operations for transferring data within a same memory hierarchy level (e.g., transferring data within the HBM 118, the DDR memory 116, the memory 106, the global scratchpad 136, or the local scratchpad 134, as non-limiting examples). In such aspects, the matrix processing unit 146(0)-146(M) may be referred to herein as “a means for rearranging a plurality of elements of a submatrix during one or more data transfer operations transferring data within a same memory hierarchy level.”

As noted above, the processor-based device 100 according to some aspects may provide a specialized instruction for performing a block-strided load operation for extracting the elements of the submatrix 304 from the input matrix 300. In such aspects, operations of blocks 500 and 504 for rearranging the plurality of elements of the first submatrix 304 and rearranging the plurality of elements of the second submatrix 306 may be performed by the matrix processing unit 146(0)-146(M) as part of performing the block-strided load operation. Accordingly, in such aspects, the matrix processing unit 146(0)-146(M) may be referred to herein as “a means for performing a block-strided load operation.” Additionally, in some aspects, the operations of blocks 500 and 504 may include performing a plurality of vector load operations (e.g., for merging smaller vectors into a larger vector in the vector registers 144(0)-144(V), as a non-limiting example). In such aspects, the matrix processing unit 146(0)-146(M) may be referred to herein as “a means for performing a plurality of vector load operations.”

Providing matrix multiplication using vector registers in processor-based devices according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

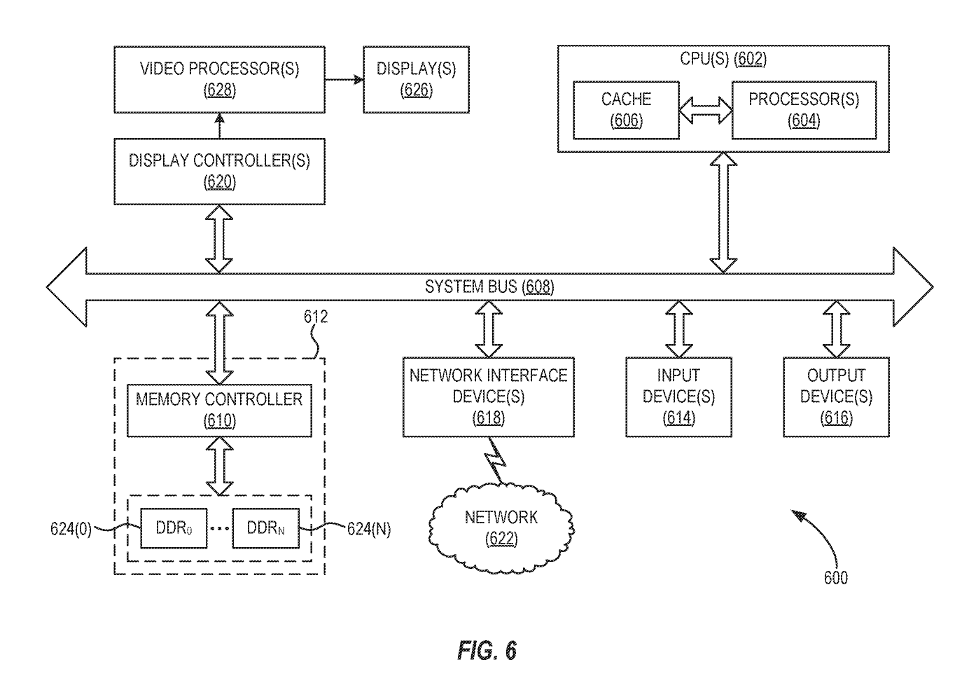

In this regard, FIG. 6 illustrates an example of a processor-based device 600 that may comprise the processor-based device 100 of FIGS. 1A and 1B. The processor-based device 600 includes one or more CPUs 602, each including one or more processors 604. The CPU(s) 602 may have cache memory 606 coupled to the processor(s) 604 for rapid access to temporarily stored data. The CPU(s) 602 is coupled to a system bus 608 and can intercouple master and slave devices included in the processor-based device 600. As is well known, the CPU(s) 602 communicates with these other devices by exchanging address, control, and data information over the system bus 608. For example, the CPU(s) 602 can communicate bus transaction requests to a memory controller 610 as an example of a slave device.

Other master and slave devices can be connected to the system bus 608. As illustrated in FIG. 6, these devices can include a memory system 612, one or more input devices 614, one or more output devices 616, one or more network interface devices 618, and one or more display controllers 620, as examples. The input device(s) 614 can include any type of input device, including but not limited to input keys, switches, voice processors, etc. The output device(s) 616 can include any type of output device, including, but not limited to, audio, video, other visual indicators, etc. The network interface device(s) 618 can be any devices configured to allow exchange of data to and from a network 622. The network 622 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 618 can be configured to support any type of communications protocol desired. The memory system 612 can include one or more memory units 624(0)-624(N).

The CPU(s) 602 may also be configured to access the display controller(s) 620 over the system bus 608 to control information sent to one or more displays 626. The display controller(s) 620 sends information to the display(s) 626 to be displayed via one or more video processors 628, which process the information to be displayed into a format suitable for the display(s) 626. The display(s) 626 can include any type of display, including, but not limited to, a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A processor-based device for performing matrix multiplication operations using vector registers, comprising:
a matrix processing unit; and
a vector processing unit comprising a plurality of vector registers;
the matrix processing unit configured to:
rearrange a plurality of elements of a first submatrix having a number R_{A} rows and a number C_{A} columns into a first vector having a number of elements equal to the product of R_{A} and C_{A}(R_{A}C_{A});
store the first vector in a first vector register of the plurality of vector registers of the vector processing unit;
rearrange a plurality of elements of a second submatrix having a number R_{B} rows and a number C_{B} columns into a second vector having a number of elements equal to the product of R_{B} and C_{B} (R_{B}C_{B}); and
store the second vector in a second vector register of the plurality of vector registers of the vector processing unit; and
the vector processing unit configured to:
perform a matrix multiplication vector operation using the first vector register and the second vector register as input operands to generate an output vector having a number of elements equal to the product of R_{A} and C_{B} (R_{A}C_{B}), wherein each element E of the output vector, where 0≤E<R_{A}C_{B}, is calculated as a dot product of a plurality of elements of the first vector corresponding to a row of the first submatrix and a plurality of elements of the second vector corresponding to a column of the second submatrix; and
store the output vector in a third vector register of the plurality of vector registers of the vector processing unit.

2. The processor-based device of claim 1, wherein the vector processing unit is configured to calculate each element E of the output vector, where 0≤E<R_{A}C_{B}, as a dot product of the plurality of elements of the first vector corresponding to a row of the first submatrix indicated by a quotient of E divided by R_{A}, and the plurality of elements of the second vector corresponding to a column of the second submatrix indicated by a remainder of E divided by C_{B}.

3. The processor-based device of claim 1, wherein the vector processing unit is configured to calculate each element E of the output vector, where 0≤E<R_{A}C_{B}, as a dot product of the plurality of elements of the first vector corresponding to a row of the first submatrix indicated by a remainder of E divided by R_{A}, and the plurality of elements of the second vector corresponding to a column of the second submatrix indicated by a quotient of E divided by C_{B}.

4. The processor-based device of claim 1, wherein:
the first submatrix comprises a tile of a plurality of tiles of a first input matrix; and
the second submatrix comprises a tile of a plurality of tiles of a second input matrix.

5. The processor-based device of claim 1, wherein the matrix processing unit is configured to rearrange one or both of the plurality of elements of the first submatrix and the plurality of elements of the second submatrix during one or more data transfer operations for transferring data from an external memory to an internal scratchpad memory.

6. The processor-based device of claim 1, wherein the matrix processing unit is configured to rearrange one or both of the plurality of elements of the first submatrix and the plurality of elements of the second submatrix during one or more data transfer operations transferring data within a same memory hierarchy level of the processor-based device.

7. The processor-based device of claim 1, wherein the matrix processing unit is configured to rearrange one or both of the plurality of elements of the first submatrix and the plurality of elements of the second submatrix as part of one or more block-strided load operations.

8. The processor-based device of claim 1, wherein the matrix processing unit is configured to rearrange one or both of the plurality of elements of the first submatrix and the plurality of elements of the second submatrix by being configured to perform a plurality of vector load operations.

9. The processor-based device of claim 1 integrated into an integrated circuit (IC).

10. The processor-based device of claim 1 integrated into a device selected from a group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

11. A processor-based device for performing matrix multiplication operations using vector registers, comprising:
a means for rearranging a plurality of elements of a first submatrix having a number R_{A} rows and a number C_{A} columns into a first vector having a number of elements equal to the product of R_{A} and C_{A} (R_{A}C_{A});
a means for storing the first vector in a first vector register of a plurality of vector registers;
a means for rearranging a plurality of elements of a second submatrix having a number R_{B} rows and a number C_{B} columns into a second vector having a number of elements equal to the product of R_{B} and C_{B} (R_{B}C_{B});
a means for storing the second vector in a second vector register of the plurality of vector registers;
a means for performing a matrix multiplication vector operation using the first vector register and the second vector register as input operands to generate an output vector having a number of elements equal to the product of R_{A} and C_{B} (R_{A}C_{B}), wherein each element E of the output vector, where 0≤E<R_{A}C_{B}, is calculated as a dot product of a plurality of elements of the first vector corresponding to a row of the first submatrix and a plurality of elements of the second vector corresponding to a column of the second submatrix; and
a means for storing the output vector in a third vector register of the plurality of vector registers.

12. The processor-based device of claim 11, wherein the means for performing the matrix multiplication vector operation comprise a means for calculating each element E of the output vector, where 0≤E<R_{A}C_{B}, as a dot product of the plurality of elements of the first vector corresponding to a row of the first submatrix indicated by a quotient of E divided by R_{A}, and the plurality of elements of the second vector corresponding to a column of the second submatrix indicated by a remainder of E divided by C_{B}.

13. The processor-based device of claim 11, wherein the means for performing the matrix multiplication vector operation comprise a means for calculating each element E of the output vector, where 0≤E<R_{A}C_{B}, as a dot product of the plurality of elements of the first vector corresponding to a row of the first submatrix indicated by a remainder of E divided by R_{A}, and the plurality of elements of the second vector corresponding to a column of the second submatrix indicated by a quotient of E divided by C_{B}.

14. The processor-based device of claim 11, wherein:
the first submatrix comprises a tile of a plurality of tiles of a first input matrix; and
the second submatrix comprises a tile of a plurality of tiles of a second input matrix.

15. The processor-based device of claim 11, wherein one or both of the means for rearranging the plurality of elements of the first submatrix and the means for rearranging the plurality of elements of the second submatrix comprise a means for rearranging a plurality of elements of a submatrix during one or more data transfer operations for transferring data from an external memory to an internal scratchpad memory.

16. The processor-based device of claim 11, wherein one or both of the means for rearranging the plurality of elements of the first submatrix and the means for rearranging the plurality of elements of the second submatrix comprise a means for rearranging a plurality of elements of a submatrix during one or more data transfer operations transferring data within a same memory hierarchy level.

17. The processor-based device of claim 11, wherein one or both of the means for rearranging the plurality of elements of the first submatrix and the means for rearranging the plurality of elements of the second submatrix comprise a means for performing a block-strided load operation.

18. The processor-based device of claim 11, wherein one or both of the means for rearranging the plurality of elements of the first submatrix and the means for rearranging the plurality of elements of the second submatrix comprise a means for performing a plurality of vector load operations.

19. A method for performing matrix multiplication operations using vector registers, comprising:
rearranging, by a matrix processing unit of a processor-based device, a plurality of elements of a first submatrix having a number R_{A} rows and a number C_{A} columns into a first vector having a number of elements equal to the product of R_{A} and C_{A} (R_{A}C_{A});
storing, by the matrix processing unit, the first vector in a first vector register of a plurality of vector registers of a vector processing unit of the processor-based device;
rearranging, by the matrix processing unit, a plurality of elements of a second submatrix having a number R_{B} rows and a number C_{B} columns into a second vector having a number of elements equal to the product of R_{B} and C_{B} (R_{B}C_{B});
storing, by the matrix processing unit, the second vector in a second vector register of the plurality of vector registers of the vector processing unit;
performing, by the vector processing unit, a matrix multiplication vector operation using the first vector register and the second vector register as input operands to generate an output vector having a number of elements equal to the product of R_{A} and C_{B} (R_{A}C_{B}), wherein each element E of the output vector, where 0≤E<R_{A}C_{B}, is calculated as a dot product of a plurality of elements of the first vector corresponding to a row of the first submatrix, and a plurality of elements of the second vector corresponding to a column of the second submatrix; and
storing, by the vector processing unit, the output vector in a third vector register of the plurality of vector registers of the vector processing unit.

20. The method of claim 19, wherein performing the matrix multiplication vector operation comprises calculating each element E of the output vector, where 0≤E<R_{A}C_{B}, as a dot product of the plurality of elements of the first vector corresponding to a row of the first submatrix indicated by a quotient of E divided by R_{A}, and the plurality of elements of the second vector corresponding to a column of the second submatrix indicated by a remainder of E divided by C_{B}.

21. The method of claim 19, wherein performing the matrix multiplication vector operation comprises calculating each element E of the output vector, where 0≤E<R_{A}C_{B}, as a dot product of the plurality of elements of the first vector corresponding to a row of the first submatrix indicated by a remainder of E divided by R_{A}, and the plurality of elements of the second vector corresponding to a column of the second submatrix indicated by a quotient of E divided by C_{B}.

22. The method of claim 19, wherein:
the first submatrix comprises a tile of a plurality of tiles of a first input matrix; and
the second submatrix comprises a tile of a plurality of tiles of a second input matrix.

23. The method of claim 19, wherein one or both of rearranging the plurality of elements of the first submatrix and rearranging the plurality of elements of the second submatrix is performed during one or more data transfer operations for transferring data from an external memory to an internal scratchpad memory.

24. The method of claim 19, wherein one or both of rearranging the plurality of elements of the first submatrix and rearranging the plurality of elements of the second submatrix is performed during one or more data transfer operations transferring data within a same memory hierarchy level.

25. The method of claim 19, wherein one or both of rearranging the plurality of elements of the first submatrix and rearranging the plurality of elements of the second submatrix is performed as part of a block-strided load operation.

26. The method of claim 19, wherein one or both of rearranging the plurality of elements of the first submatrix and rearranging the plurality of elements of the second submatrix comprises performing a plurality of vector load operations.
